(19) United States
(12) Patent Application Publication
(10) Pub. No.: US 2017/0232549 A1
(43) Pub. Date: Aug. 17, 2017

(54) Method for Shipbuilding Using 3D Printers

(71) Applicants: Alberto Daniel Lacaze, Potomac, MD (US); Karl Murphy, Rockville, MD (US)

(72) Inventors: Alberto Daniel Lacaze, Potomac, MD (US); Karl Murphy, Rockville, MD (US)

(21) Appl. No.: 15/269,885

(22) Filed: Sep. 19, 2016

Related U.S. Application Data
(60) Provisional application No. 62/257,572, filed on Nov. 19, 2015.

(51) Int. Cl. B23K 15/00; B33Y 10/00; B33Y 40/00; B33Y 50/02; B33Y 80/00; B63B 9/06; B23K 26/342; B23K 26/03; B23K 26/08; B23K 26/70; B63B 3/00; B29C 67/00; B23K 15/02

(52) U.S. Cl. CPC B23K 15/0086; B29C 67/0088; B33Y 10/00; B33Y 40/00; B33Y 50/02; B33Y 80/00; B23K 15/0006; B23K 15/02; B23K 26/342; B23K 26/032; B23K 26/0884; B23K 26/702; B63B 3/00; B63B 9/06; B29L 2031/3067

(57) ABSTRACT

Building a complete ship hull, including many internals (bulkhead, holds), as a single, 3D printed device. A Stewart crane is used for gross positioning, while a multitude of beam deposition arms can be used for finer positioning. In a shipbuilding method, this means that the hull, floors, main piping, tanks, quarters, stairs, doorways, etc. can all be printed, in place, as part of a multi-step process.

### CROSS REFERENCE TO RELATED APPLICATIONS:

This application claims priority from U.S. patent application Ser. No. 62/257,572, entitled “Method for Shipbuilding Using 3D Printers”, filed on Nov. 11, 2015 The benefit under 35 USC §119(e) of the U.S. provisional application is hereby claimed, and the aforementioned application is hereby incorporated herein by reference.

### TECHNICAL FIELD OF THE INVENTION

The present invention relates generally to 3D printing solutions. More specifically, the present invention relates to deployed, rapid 3D printable solutions.

### BACKGROUND OF THE INVENTION

The cost of shipbuilding is significantly driven by labor; the other 30-70% of shipbuilding costs depend on the complexity of the project. Shipbuilding is highly labor intensive, though many shipbuilding expenses are also due to custom, subcomponent costs.

3D printing provides the architectural and material freedom needed to support modern day shipbuilding. Especially when compared to the wasteful practice of machining custom components, using 3D printing diminishes material waste. 3D printing also offers savings in fabrication time, as 3D printed parts can be made faster than machined parts. 3D printing even offers weight savings, as new designs using lighter materials can be substituted or combined with required steel or heavier materials. This is either impossible or expensive to do during the custom machining process, or during a complex, multi-step manufacturing process.

### DEFINITIONS

Direct metal sintering (DMLS).

A Gough-Stewart platform is a type of parallel robot that has six prismatic actuators, commonly hydraulic jacks or electric actuators, attached in pairs to three positions on the platform's baseplate, crossing over to three mounting points on a top plate. Devices placed on the top plate can be moved in the six degrees of freedom in which it is possible for a freely-suspended body to move. These are the three linear movements x, y, z (lateral, longitudinal and vertical), and the three rotations pitch, roll, & yaw. The terms “six-axis” or “6-DoF” (Degrees of Freedom) platform are also used, also “synergistic”.

Selective laser sintering (SLS).

### SUMMARY OF THE INVENTION

3D printing enables the production of high accuracy parts, printed with various metals, whether large or small, with incredible detail—detail matching that of the most accurate machining techniques. In contrast, 3D printing also provides for low accuracy, large volume methods, available as COTS.

Direct metal sintering (DMLS) and selective laser sintering (SLS) are also available production techniques that can create very accurate parts, but such techniques require power beds and are not suited for large parts.

Laser metal deposition, Electronic Beam Metal Manufacturing, and Selective Laser melting provide deposition rates in 10's of kg an hour, use a variety of materials (aluminum, titanium, and steel), and are commercially available. These three methods reduce internal stresses (as opposed to welding, milling or machining), and the heads can print multiple materials, which becomes very important when creating internal components of ships and boats.

### BRIEF DESCRIPTION OF THE DRAWINGS

The accompanying drawings, which are incorporated herein and form a part of the specification, illustrate the present invention and, together with the description, further serve to explain the principles of the invention, enabling a person skilled in the pertinent art to make and use the invention.

FIG. 1 illustrates a Stewart Manipulator for providing accurate positioning, as partially developed by the initial applicants of the present invention.

FIG. 2 illustrates a concept shipbuilding support and movement apparatus taught by the present invention.

FIG. 3 illustrates the side deflection computation taught by the present invention.

FIG. 4 illustrates a macro/micro manipulator crane as taught by the present invention.

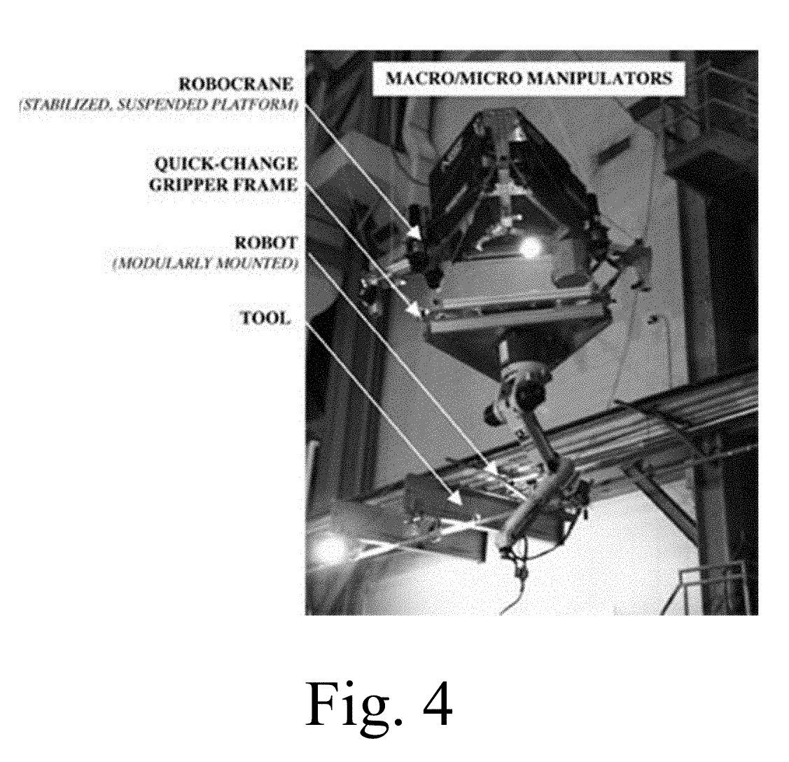

FIG. 5 illustrates an end manipulator arm.

FIG. 6 illustrates yet another Stewart for higher precision.

FIG. 7 is a chart illustrating the density and compressive strength of different materials.

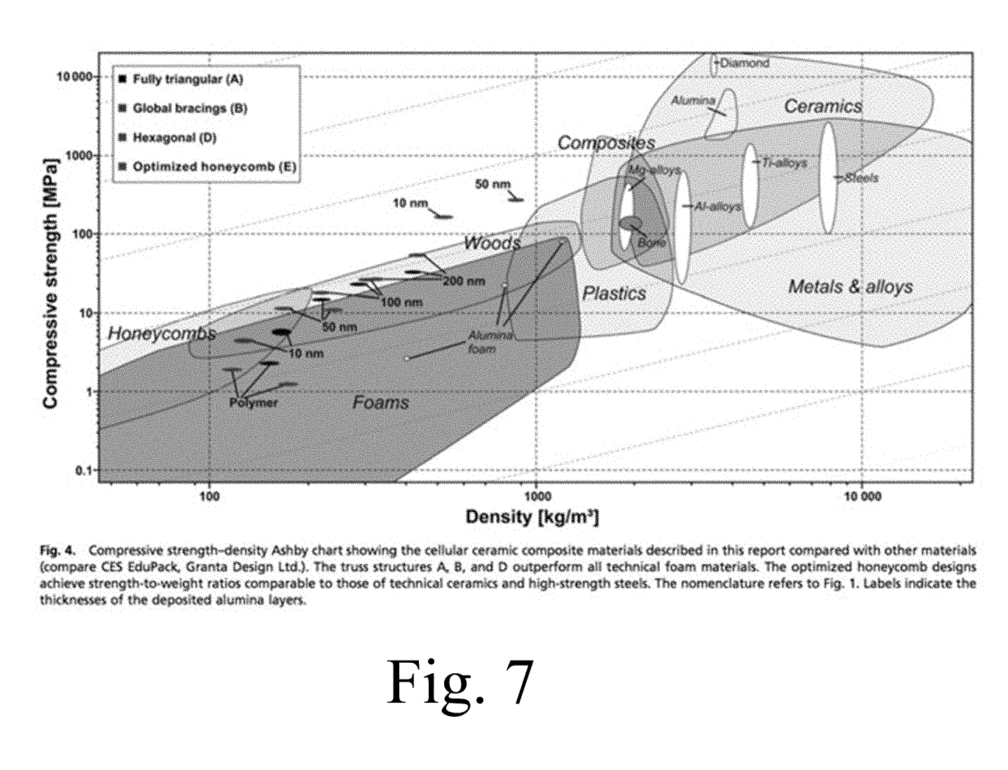

### DETAILED DESCRIPTION OF THE INVENTION

In the following detailed description of the exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized, and logical, mechanical, electrical, and other changes may be made without departing from the scope of the present invention. The following detailed description is, therefore, not to be taken in a limiting sense, and the scope of the present invention is defined only by the appended claims.

In the following description, numerous, specific details are set forth to provide a thorough understanding of the invention. However, it is understood that the invention may be practiced without these specific details. In other instances, well-known structures and techniques, known to one of ordinary skill in the art, have not been shown in detail, so as to avoid obscuring the invention. Referring to the figures, it is possible to see the various major elements constituting the apparatus of the present invention.

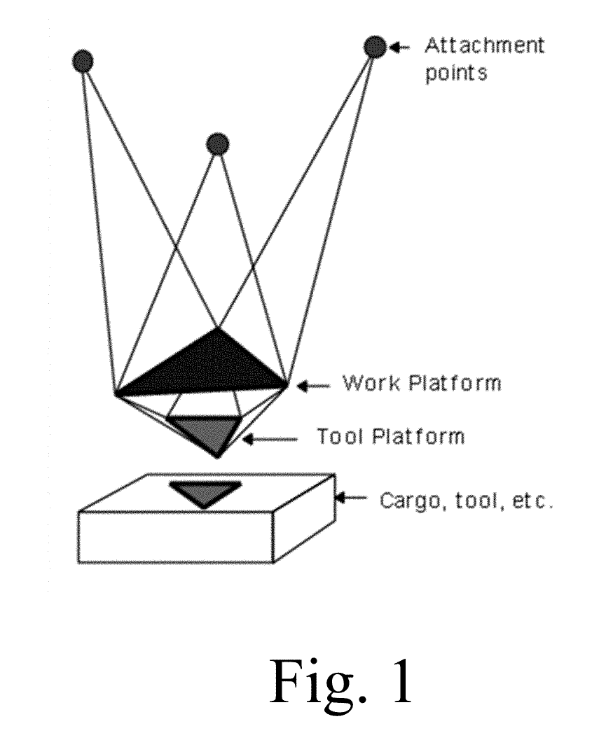

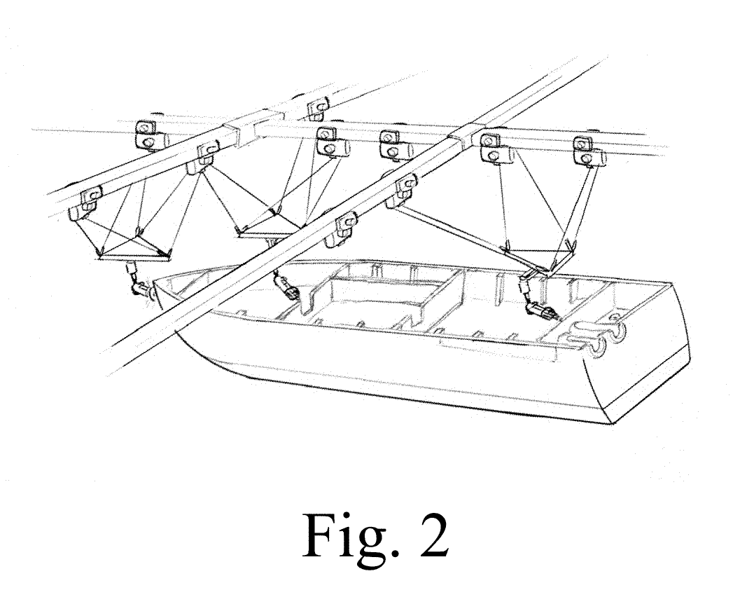

Building a complete ship hull, including many internal structures (bulkhead, holds), as a single 3D printed device, is now possible. As show in FIG. 1, during and after printing, a Stewart crane could, in an assembly process, be used for gross positioning, while a multitude of beam deposition arms could be used for finer positioning. In a shipbuilding method, this means that the hull, floors, main piping, tanks, quarters, stairs, doorways, etc. can all be printed in place, as part of a multi-step process as shown in FIG. 2.

The method taught by the present invention addresses many challenges currently existing in shipbuilding, which include: accurate positioning of the printing end effector; accurate positioning of the grinding head; sufficient work volume; physical properties of the resulting ship; cost of infrastructure (NRE) and cost of supplies; sufficient Kg/hour on print heads; short enough build time, and design differences.

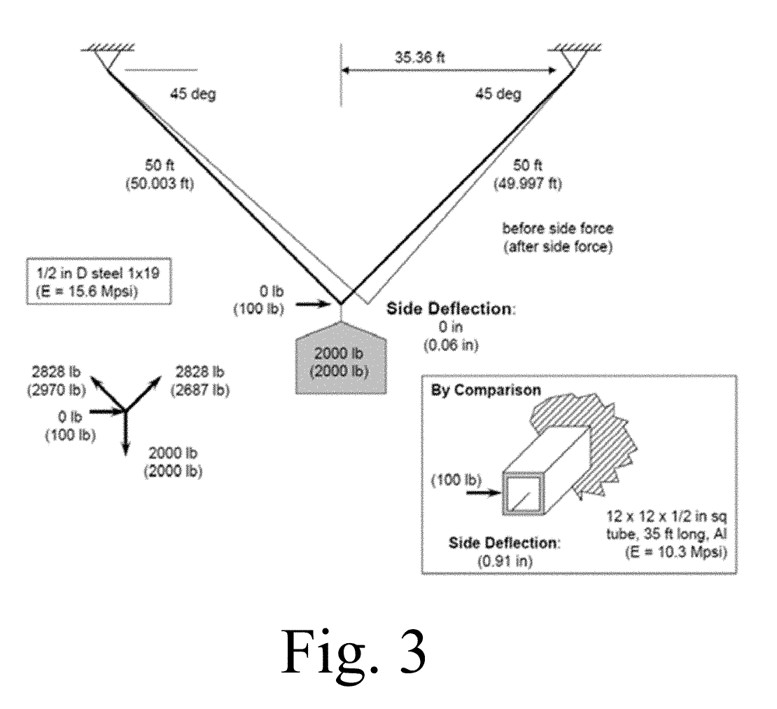

The use of a Stewart Crane or Manipulator is important, because it provides the necessary stability, control, and localization required for precise printing. FIG. 3 illustrates the side deflection computation.

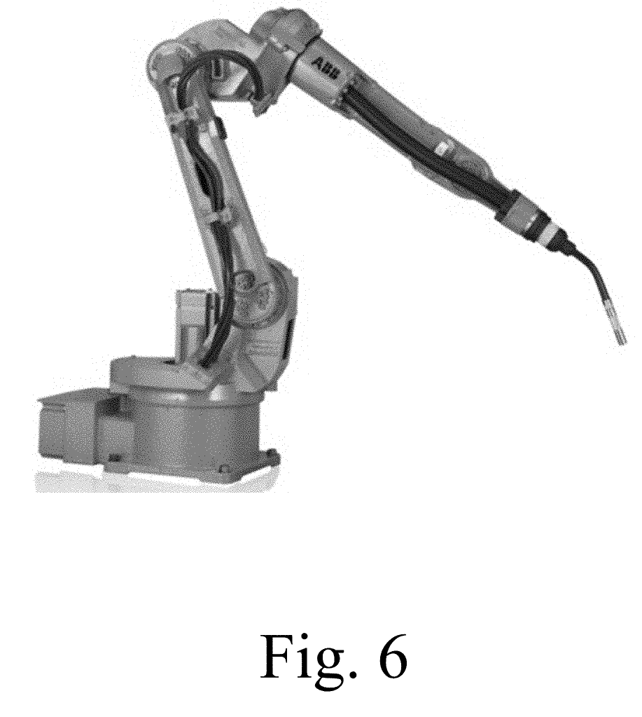

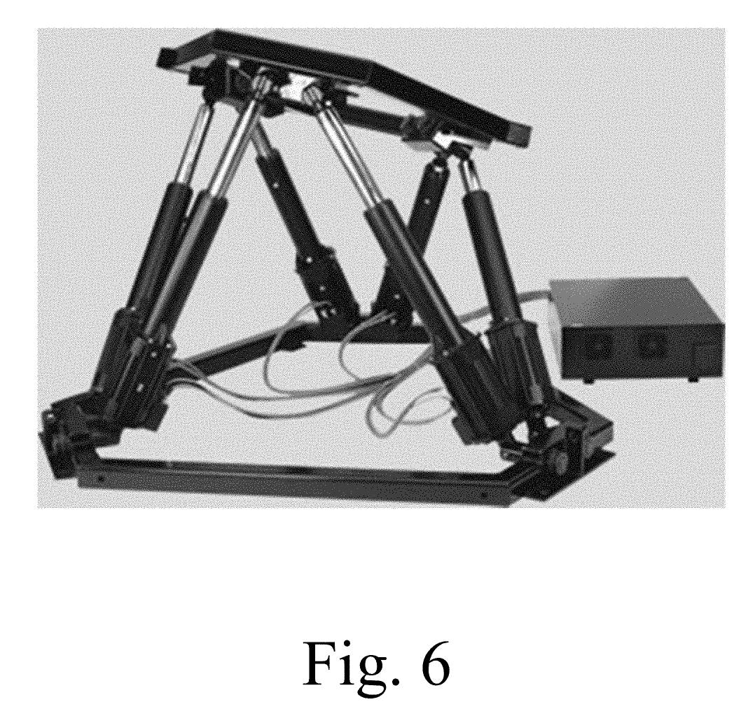

FIG. 5 illustrates an end manipulator arm for low precision, longer reach. FIG. 6 illustrates yet another Stewart for higher precision. The Stewart Crane will do coarse positioning, mostly on open loop motion; then, the end manipulator will position a 3D printing head (and/or mill) using laser feedback.

Predicting the physical properties of 3D printed metals is still in its infancy. LLNL (https://acamm.llnl.gov/) has created a certification process to accredit additively manufactured metals. This creates a set of measured, physical properties that will be used to predict the macro properties of the device. FIG. 5 is a chart illustrating the density and compressive strength of different materials.

In the future, design techniques, such as honeycombing, can further improve the properties of the ship.

Based on the inventors' rough assumptions, it should take eighty-one days to print, using two print heads running non-stop with a print throughput per head of 10 kilograms per hour. This would produce a ship of approximately sixty-five thousand kilograms in weight, with sixty percent 3D printable content.

Consumables for a bulk printed ship would include bulk aluminum, at a cost of eighty thousand dollars, with about fifty percent wasted. The use of power is negligible in view of the costs of consumables.

The present invention provides many advantages: lower cost; material and design freedom, which comes with possible weight advantages; manufacturing speed advantages; reduced residual stress, and the return of ship manufacturing to the U.S.

The inventors are currently developing a pilot program to 3D print a 45-foot ship in eighteen months.

The inventors have already solved the large work volume control problem. The inventors have already solved the large work volume accurate positioning problem by using the disclosed robo cranes. The inventors have state of the art printing capabilities and access to testing capabilities, both destructive and non-destructive. The inventors are already commercially selling devices that do this at a smaller scale and are known for already creating innovative technologies in the 3D printing area.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Thus, it is appreciated that the optimum dimensional relationships for the parts of the invention, to include variation in size, materials, shape, form, function, and manner of operation, assembly, and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

1. A method for shipbuilding, where the entirety of the ship or boat, including the bulkhead, holds, and other interior structures, is constructed by printing consecutive slices, starting at the base of the hull and ending at the top most part of the bridge, comprising the following steps:
a) software, capable of horizontally slicing the CAD models of the hull and some, or all, of the internals of the ship;
b) one or more 3D printers that can print metal or composites;
c) a method for depositing the material for each slice, starting from the bottom of the ship and incrementally filling all slices, upward, until the ship is completed; and
d) a process, using a Stewart Platform, to position the printer's effector in the workspace, as defined by each slice.

2. The method in claim 1, where the classical Stewart Platform is modified to use three or more cables instead of the classical six cables.

3. The method in claim 1, wherein the classical Stewart uses solid beams instead of cables.

4. The method in claim 1, wherein a finer positioning sequential arm or smaller Stewart is used at the end of the Stewart activator.

5. The method of claim 1, wherein the hull, floors, main piping, tanks, quarters, stairs, and doorways are all printed, in place, as part of a multi-step process.

6. The method of claim 1, wherein the Stewart Crane or Manipulator provides the necessary stability, control, and localization required for precise printing.

7. The method of claim 1, wherein an end manipulator arm is used for low precision and longer reach.

8. The method of claim 1, wherein the Stewart Crane will do coarse positioning, mostly on open loop motion; then, the end manipulator will position a 3D printing head and/or mill using laser feedback.

9. The method of claim 1, wherein the slicing technique in step b provides honeycombing, or other structural stable techniques, to reduce weight, and improve the properties of the ship.

10. The method of claim 1, wherein
the slicing, rather than being horizontal, slices through the models at an arbitrary angle; and
the printing can be achieved from the first layer to the last, either horizontally, or at some other angle.

11. The method of claim 1, wherein the other end effectors are added to the Stewart, including, but not limited to: grinder, painter, sander, coater, sand-blaster, drill, vacuum, saw, welder, mill, camera, touch probe, optical probe, hyper-spectral camera, LADAR, acoustic sensor, gas detector, gas injector, or sprayer.

12. The method of claim 1, wherein the model of the complete ship or boat is vertically sliced into sections, and the printing process occurs one section at a time.

13. The method of claim 1, wherein further comprising of a method for detecting collision between the Stewart manipulators or the end effectors.

14. The method of claim 1, wherein further comprising of an interweaving of printing and grinding; or, printing and painting; or, printing and spraying; or, printing and inspecting using the end effectors included in claim 11.

15. The method of claim 1, wherein further comprising of a mechanism for fusing adjacent devices in the CAD model. For example, a coat hook (which originally had to be screwed into the wall), would now be fused into the model of the wall, printed as a single entity (without the need of the screw).

16. The method of claim 1, wherein
a metal or composite is used as support when printing some areas of the ship; areas which would otherwise bend due to the effects of gravity; and
these temporary support widgets would be manually or automatically removed as part of the building process.

17. The method of claim 1, wherein the print is either fully or partially submerged in water, or some other liquid, during the printing process, in order to change the properties of the internal stresses of the material; to provide cooling for the process; or, to electroplate.

18. The method of claim 1, wherein the print is fully or partially enclosed in gas to improve the printing process.

19. The method of claim 1, wherein non-3D printable items are placed into cavities in the hull; cavities that would otherwise not be accessible at the ship or boat's completion.
